(19) United States
(12) Patent Application Publication
(10) Pub. No.: US 2022/0125103 A1
(43) Pub. Date: Apr. 28, 2022

(54) HEATING CUP

(71) Applicant: Shenzhen Eigate Technology Co., Ltd., Shenzhen (CN)

(72) Inventor: Tuanfang LIU, Shenzhen (CN)

(21) Appl. No.: 17/117,091

(22) Filed: Dec. 9, 2020

(30) Foreign Application Priority Data
Oct. 25, 2020 (CN) 202011151198.5
Oct. 25, 2020 (CN) 202022389624.0

(51) Int. Cl. A24F 1/32; A24F 40/20; A24F 40/42; A24F 40/48; A24F 40/465; A24F 1/30; A24F 5/06; H05B 6/10

(52) U.S. Cl. CPC A24F 1/32; A24F 40/20; A24F 40/42; H05B 6/105; A24F 40/465; A24F 1/30; A24F 5/06; A24F 40/48

(57) ABSTRACT

A heating cup includes a container, an air vent, a metal conductor, and a cup body. The metal conductor is inlaid in the container. The container includes a side wall and the air vent is disposed on the side wall to allow air and smoke to pass through. The container is disposed in the cup body and is configured to accommodate a tobacco material.

### CROSS-REFERENCE TO RELATED APPLICATIONS

Pursuant to 35 U.S.C. § 119 and the Paris Convention Treaty, this application claims foreign priority to Chinese Patent Application No. 202011151198.5 filed on Oct. 25, 2020, and to Chinese Patent Application No. 202022389624.0 filed on Oct. 25, 2020. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a heating cup.

Conventional heating cups using magnetic induction effect to heat tobacco material include a magnetic induction coil and a container accommodating tobacco material. The magnetic induction coil is fixed on the container. The container is made of metal.

### SUMMARY

The disclosure provides a heating cup, comprising a container, an air vent, a metal conductor, and a cup body; the metal conductor is inlaid in the container; the container comprises a side wall and the air vent is disposed on the side wall to allow air and smoke to pass through; and the container is disposed in the cup body and is configured to accommodate a tobacco material.

In a class of this embodiment, the container comprises glass and the metal conductor is inlaid in the glass.

In a class of this embodiment, the cup body comprises a gas passage separated from the metal conductor inlaid in the container.

In a class of this embodiment, the gas passage comprises a gap between the container and the cup body and a cavity of the cup body

In a class of this embodiment, a plurality of air vents is disposed on the side wall and each air vent is in the shape of circle, triangle, quadrilateral, or polygon; the side wall is a network structure or a sieve structure; and each air vent communicates with the gas passage.

In a class of this embodiment, the container and the cup body comprise glass, ceramics, quartz, crystal, mica, jade, or a combination thereof.

In a class of this embodiment, the shape of the cup body comprises cylinder, square, S-shape, and L-shape.

In a class of this embodiment, the container is separable from the cup body.

In a class of this embodiment, the heating cup is used in combination with a high frequency heating device; when in use, the high frequency heating device is disposed on the cup body; in the power-on state, the metal conductor produces heat and transfer the heat to the container whereby the tobacco material is heated and smoke is produced.

In a class of this embodiment, the heating cup is used in combination with a smoke filter; when in use, the smoke enters the smoke filter, is filtered by water therein, and flows to an outlet of the smoke filter for user's inhaling.

### BRIEF DESCRIPTION OF THE DRAWINGS

FIG. 1 is an exploded view of a heating cup in accordance with one embodiment of the disclosure;

FIG. 2 is a sectional view of a heating cup in accordance with one embodiment of the disclosure;

FIG. 3 is a schematic diagram of a heating cup in accordance with one embodiment of the disclosure;

FIG. 4 shows a combination of a smoke filter and a heating cup in accordance with one embodiment of the disclosure;

FIG. 5 shows a combination of a high frequency heating device and a heating cup in accordance with one embodiment of the disclosure;

FIG. 6 shows a schematic diagram of a heating cup according to another embodiment of the disclosure; and

FIG. 7 shows an airflow direction of a heating cup of the disclosure.

### DETAILED DESCRIPTION

To further illustrate, embodiments detailing a heating cup are described below. It should be noted that the following embodiments are intended to describe and not to limit the disclosure.

Tobacco materials refer to tobacco tar, tobacco paste, tobacco leaf and other materials used to produce smoke.

Optionally, the heating cup 1 of the disclosure is made of metal material, or part of the heating cup is made of metal material, or the heating cup is made of glass, ceramics, quartz, crystal, mica, and jade inlaid with metal material.

In certain embodiments, the heating cup is a one-piece glass structure and can be optionally used in combination with a smoke filter.

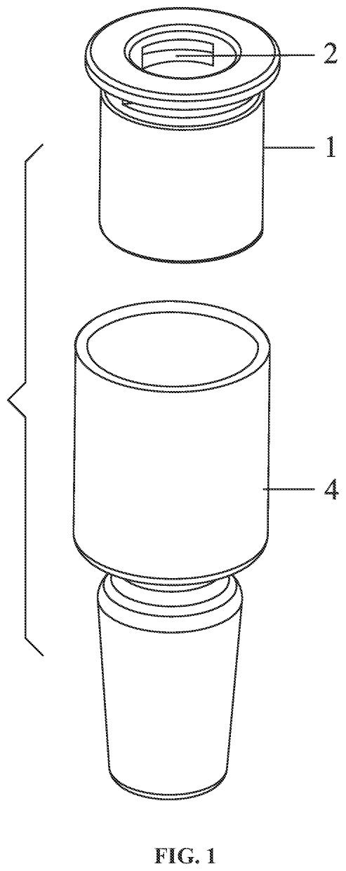

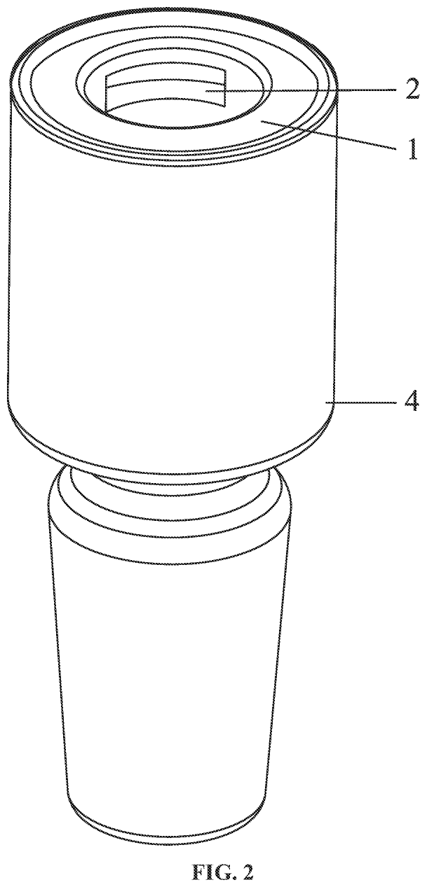

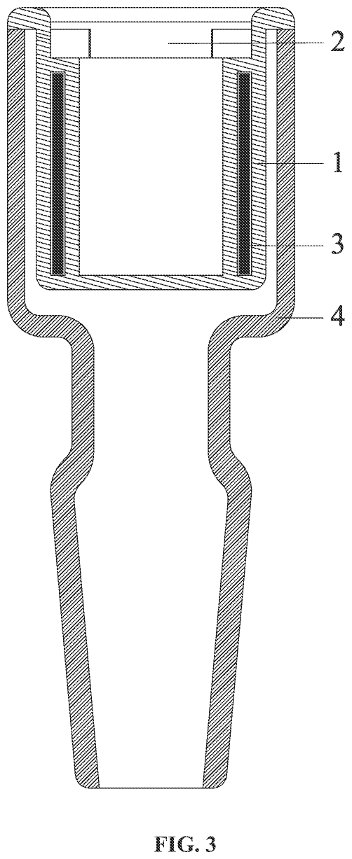

As shown in FIGS. 1-3, the heating cup comprises a container 1, an air vent 2, a metal conductor 3, and a cup body 4. The metal conductor is inlaid in the container 1. The container is configured to accommodate a tobacco material. The metal conductor 3 is configured to produce heat and transfer the heat to the container 1 whereby the tobacco material is heated and smoke is produced. The container is made of glass and the metal conductor is inlaid in the glass. The container 1 comprises a side wall and the air vent 2 is disposed on the side wall to allow air and smoke to pass through. The container is disposed in the cup body 4. The cup body 4 is FIGS. 1-3 is just illustrative, and can be presented in other forms.

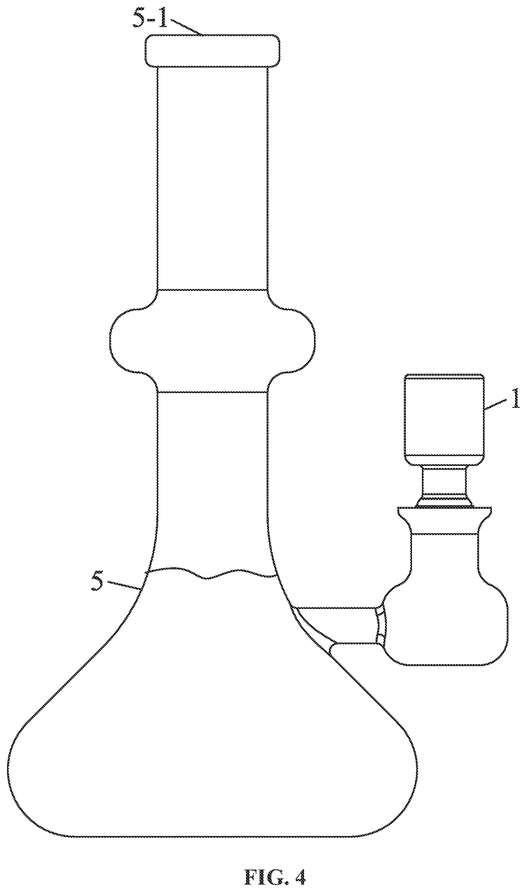

As shown in FIG. 4, the disclosure also provides a smoke filter 5 used in combination with the heating cup. The smoke filter is just illustrative, and can be presented in other forms to cooperate with the heating cup of the disclosure.

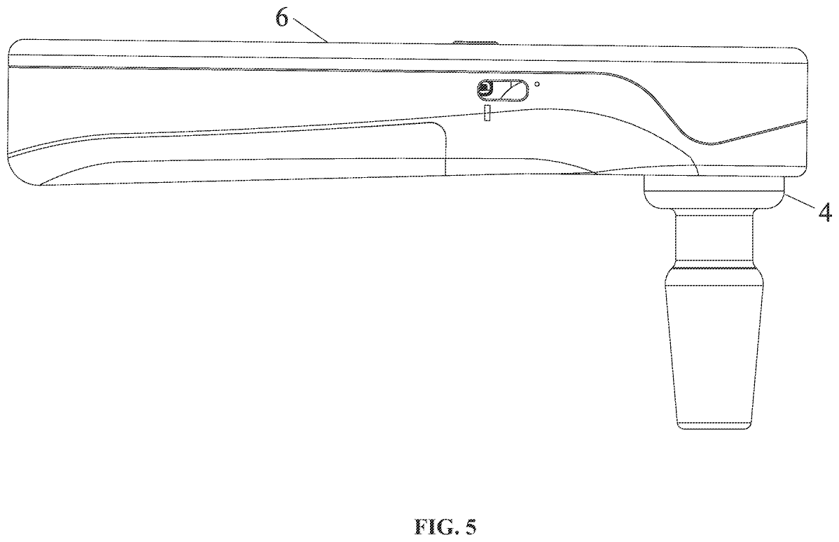

As shown in FIG. 5, when in use, a high frequency heating device 6 is disposed on the cup body 4 and matches the metal conductor 3. In the power-on state, the metal conductor produces heat and transfer the heat to the container 1 whereby the tobacco material is heated and smoke is produced. The air enters the container from the top opening thereof and drives the smoke to pass through the air vent 2 on the side wall of the container. Thereafter, the smoke enters the smoke filter 5, is filtered by water therein, and flows to the outlet 5-1 of the smoke filter for user's inhaling.

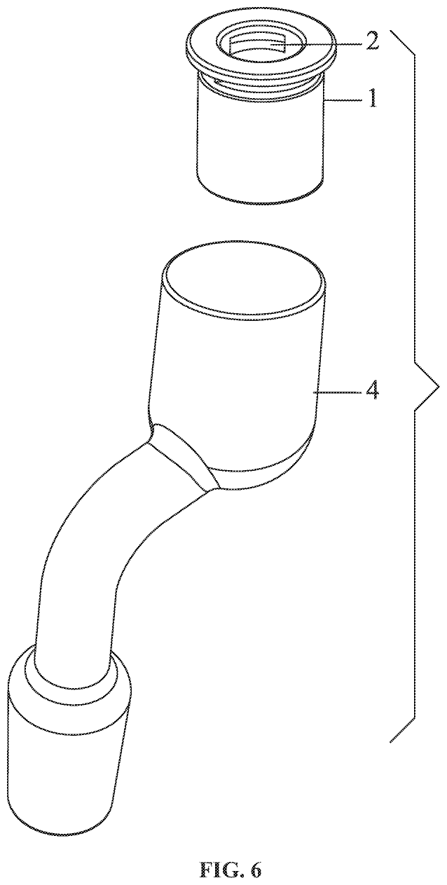

FIG. 6 shows a schematic diagram of the heating cup according to another embodiment of the disclosure.

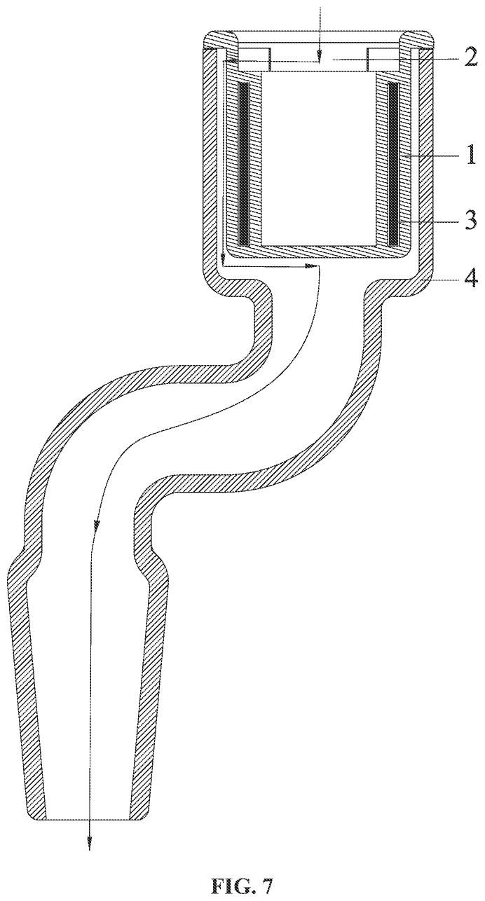

FIG. 7 shows an airflow direction of the heating cup of the disclosure.

The following advantages are associated with the heating cup of the disclosure:

1. The heating cup is independent from a high frequency heating device and is connected to the high frequency heating device when in use, so the produced smoke does not flow to the high frequency heating device, which is environmentally friendly.

2. The container comprises glass and the metal conductor is inlaid in the glass, which improves the efficiency of the heat transfer.

3. The container comprises a gas passage separated from the metal conductor. The gas passage allows air and smoke to pass through. The heating cup is multifunctional.

4. The container is disposed in the cup body and is freely taken out of the cup body, which is conducive to the replacement and cleaning of the container.

It will be obvious to those skilled in the art that changes and modifications may be made, and therefore, the aim in the appended claims is to cover all such changes and modifications.

What is claimed is:

1. A heating cup, comprising a container, an air vent, a metal conductor, and a cup body; wherein the metal conductor is inlaid in the container; the container comprises a side wall and the air vent is disposed on the side wall to allow air and smoke to pass through; and the container is disposed in the cup body and is configured to accommodate a tobacco material.

2. The heating cup of claim 1, wherein the container comprises glass and the metal conductor is inlaid in the glass.

3. The heating cup of claim 2, wherein the cup body comprises a gas passage separated from the metal conductor inlaid in the container.

4. The heating cup of claim 3, wherein the gas passage comprises a gap between the container and the cup body, and a cavity of the cup body.

5. The heating cup of claim 3, wherein a plurality of air vents is disposed on the side wall and each air vent is in the shape of circle, triangle, quadrilateral, or polygon; the side wall is a network structure or a sieve structure; and each air vent communicates with the gas passage.

6. The heating cup of claim 4, wherein the container and the cup body comprise glass, ceramics, quartz, crystal, mica, jade, or a combination thereof.

7. The heating cup of claim 4, wherein a shape of the cup body comprises cylinder, square, S-shape, and L-shape.

8. The heating cup of claim 1, wherein the container is separable from the cup body.

9. The heating cup of claim 1, wherein the heating cup is used in combination with a high frequency heating device; when in use, the high frequency heating device is disposed on the cup body; in the power-on state, the metal conductor produces heat and transfer the heat to the container whereby the tobacco material is heated and smoke is produced.

10. The heating cup of claim 1, wherein the heating cup is used in combination with a smoke filter; when in use, the smoke enters the smoke filter, is filtered by water therein, and flows to an outlet of the smoke filter for user's inhaling.
